(19) United States
(12) Patent Application Publication
(10) Pub. No.: US 2016/0185064 A1
(43) Pub. Date: Jun. 30, 2016

(54) PUNCH DESIGN

(71) Applicant: Thomas Blaszczykiewicz, Orchard Park, NY (US)

(72) Inventor: Thomas Blaszczykiewicz, Orchard Park, NY (US)

(21) Appl. No.: 14/822,931

(22) Filed: Aug. 11, 2015

Related U.S. Application Data
(60) Provisional application No. 62/035,742, filed on Aug. 11, 2014.

(51) Int. Cl. B30B 15/06; B23P 11/02; A61J 3/10; B30B 11/04

(52) U.S. Cl. CPC B30B 15/065; B30B 11/04; B23P 11/027; A61J 3/10; B29K 2105/251

(57) ABSTRACT

A method and apparatus for a removable and replaceable wear portion made of a variety of ceramic materials for pistons or plungers utilized in pumps, motors, presses, and other mechanical devices.

### CROSS REFERENCE TO RELATED APPLICATIONS

This application is related to and claims priority to U.S. Provisional Patent Application No. 62/035,742 filed on Aug. 11, 2014.

### TECHNICAL FIELD

The present novel technology relates generally to mechanical engineering, and more particularly, to a piston or punch member having a head with a replicable, wear reducing ceramic insert.

### BACKGROUND

Compaction systems that utilize pistons or plungers as punchers to compress solids, fluids, or the like, are employed in various industries, such as industrial, oil and gas, core drilling and mining, compaction tooling and tableting equipment for the pharmaceutical industry, and power jet markets. During the compaction process, however, the application of significant compressive forces results in wear to the tips and heads of the punches. This force, associated friction and the nature of the materials being compacted, causes a high level of wear on the compaction tooling, resulting in the frequent need to change out and rework such tooling. Today, pistons are utilized for their limited life span, and are replaced with a brand new piston, manufactured with all new materials, labor, and freight.

Although it is known to employ ceramics in the interior region of the die, to reduce the wear from friction, easily replaceable or refurbishable tools such as compaction punches or pistons, possibly including ceramics, have not been successfully employed in a manner that allows the piston to be repaired on-site or through recyclable replacement parts, with minimal time in which the machine is down for repair. Furthermore, a method for a quick and cost effective manner in which the piston is repaired and/or replaced has not been successfully employed. Thus, it is often the case that frequent replacement of punches and center pins continues to be a problem and cost that plagues the compaction industry. The present novel technology addresses this need.

### BRIEF DESCRIPTION OF THE DRAWINGS

FIG. 1 is a side view of a punch known in the industry.

FIG. 2 is a side view of a punch according to one embodiment of the disclosed technology.

FIG. 3 is a top plan view of the head of the punch shown in FIG. 2 taken along line 6-6.

FIG. 4 is a side view of a punch according to another embodiment of the disclosed technology.

### DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

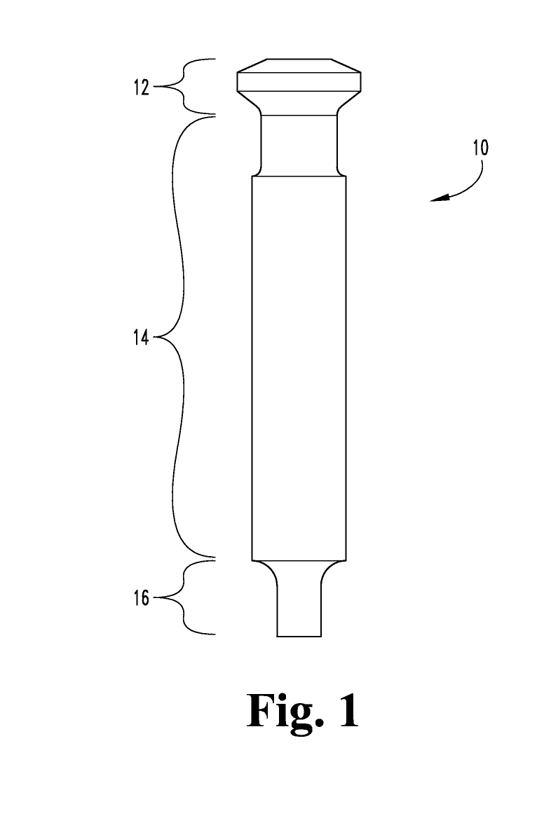

FIG. 1 shows a punch or piston tool known in the industry. The punch 10 typically comprises three main portions: the tip portion 16, the barrel portion 14, and the head portion 12. Such tools may be made from a variety of materials, but are typically made of metals such as steel. The punch may be used alone or in conjunction with a second punch, a corresponding die, or a combination thereof. When used in machines such punches are commonly driven by a cam riding against the head portion of the piston so as to generate a reciprocating motion.

Punches are commonly used in the pharmaceutical industry to form medicament materials into tablets in machines known as tablet presses. A tablet is formed by the combined pressing action of two punches and a die. In the first step of a typical operation, the bottom punch is lowered in the die creating a cavity into which the granulated feedstock is fed. The exact depth of the lower punch can be precisely controlled to meter the amount of powder that fills the cavity. The excess is scraped from the top of the die, and the lower punch is drawn down and temporarily covered to prevent spillage. Then, the upper punch is brought down into contact with the powder as the cover is removed. The force of compression is delivered by high pressure compression rolls which fuse the granulated material together into a hard tablet. After compression, the lower punch is raised to eject the tablet.

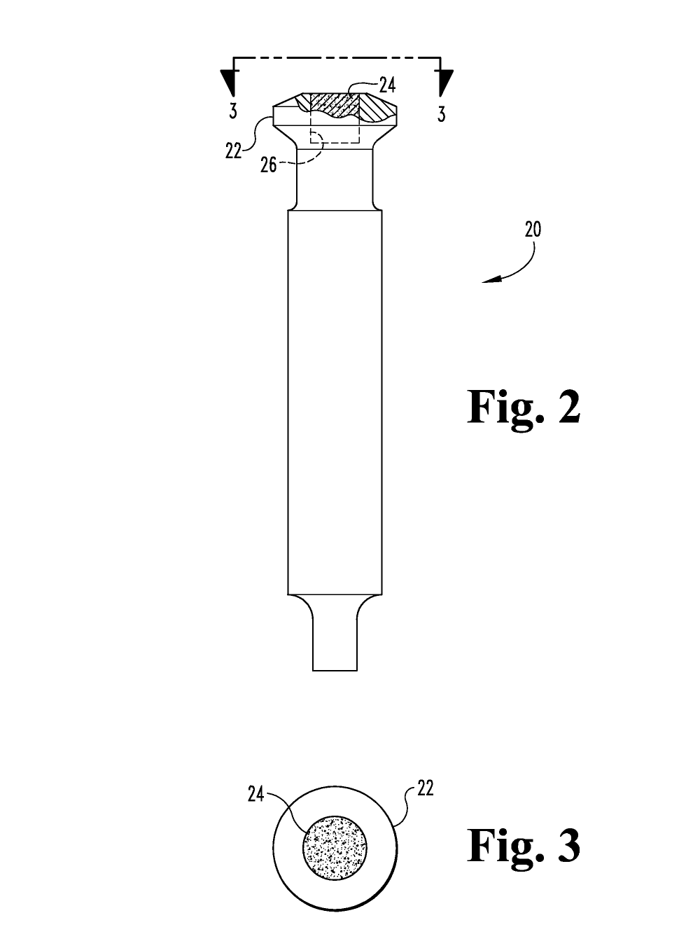

FIG. 2 shows a punch 20 according to one embodiment of the disclosed technology. In this particular example, the punch may be an upper or a lower punch. A portion of the head 22 of the steel punch has been removed and a ceramic body 24 has been positioned therein. The removed portion is bored out using a drill or other suitable tool to a desired depth and diameter creating a cavity 26. The cavity 26 is sized a configured according to the ceramic body 24 which is to be placed therein. Heat induction is used to increase the diameter of the cavity 26 so the ceramic body 24 can be placed. Once the ceramic body 24 is positioned the tooling is allowed to cool. The cavity 26 contracts and the ceramic body 24 is secured firmly in place by an interference fit. FIG. 3 shows a top plan view of the face of the head portion of the punch 20. The diameter of the ceramic body may be larger or smaller relative to the overall diameter of the head portion as desired. In one example the ceramic portion comprises at least 50% of the surface of the face of the head portion. In another example, the ceramic portion comprises at least 75% of the surface of the face of the head portion.

The exact formulation of the ceramic material which comprises the ceramic body may vary as desired. Typically, a ceramic material will have greatly improved wear characteristic when compared to steel. These characteristic will give the punch tool an increased lifespan over an unmodified tool leading to lower cost of operation, lower maintenance costs, increased machine operational speeds, and decreased downtime for repair. Because the head portion of a punch tool typically wears out much faster than the other parts, when the ceramic insert does eventually wear down the tool may be reconditioned by replacing the ceramic insert and the tool may be returned to service. Currently punch tools are discarded and replaced once the head portion is worn beyond an acceptable level.

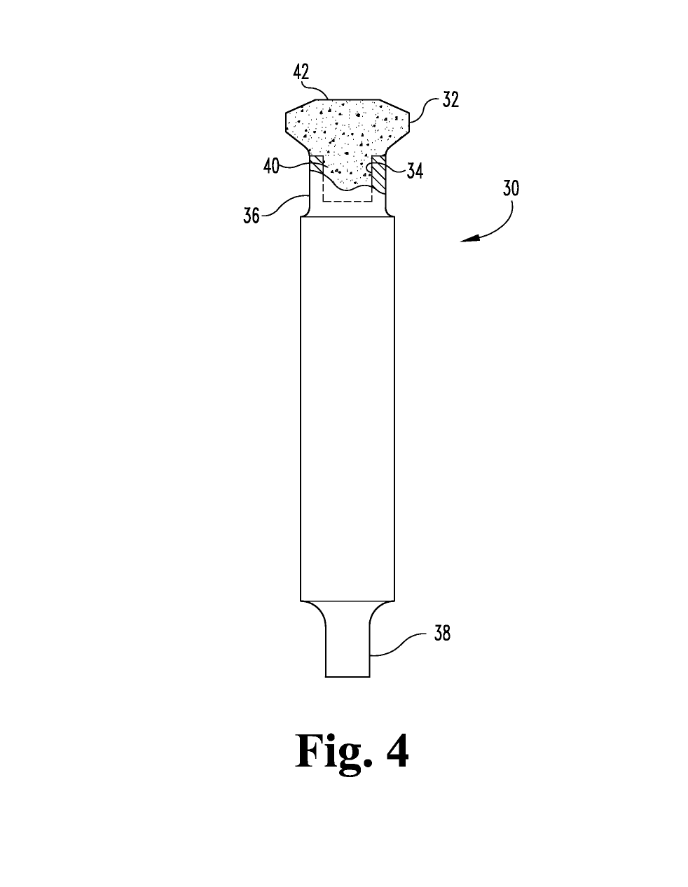

Another example of the disclosed technology is shown in FIG. 4. In this particular example, a piston 30 is fabricated from steel without a head portion. The body portion 36 and the tip portion 38 are fabricated using typical processes. A head portion 32 is formed from a ceramic material, the exact formulation of which can vary as desired. The head portion 32 comprises a contacting portion 42 sized and configured for contacting the cam or other driving mechanism in a pressing machine and a neck portion 40 sized and configured for mating the head portion 32 with the piston 30. A cavity 34 is formed in the body portion 36 of the piston 30 using a drill or other suitable machining method. The piston is then heated using heat induction or some other suitable method to increase the diameter of the cavity 34 so as to allow the neck 40 of ceramic head portion 32 to be inserted therein. Once cooled cavity 34 contracts and forms an interference fit with neck 40 thereby securing ceramic head portion 32 to piston 30. The tool produced in this example has a head surface which is effectively 100% ceramic material. When head portion 32 eventually wears down it may be replaced in a similar fashion to the replacement procedure described with respect to the embodiment shown in FIGS. 2-3.

The tools shown in these examples are for illustrative purposes only. The disclosed technology could be applied to punches, pistons, and similar tools of a variety of different lengths and diameters. The disclosed technology could also be adapted for use with tool heads having shapes, sizes, and configurations other than hose shown here. One of ordinary skill in the art would understand how to adapt the disclosed technology to such tooling as desired.

The disclosed technology could also be adapted to place a ceramic body in the tip portion of a punch tool as desired. Currently health and safety regulations prohibit the use of non-magnetic or otherwise non-detectable materials which come into contact with pharmaceutical tablets. These regulations are intended to prevent contamination of tablets with an undetectable material from the punch or die as the tools wear. If a ceramic material were developed which could satisfy these health and safety regulations then the present technology could be adapted to replace a portion of the piston tip with such a material as well.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A punch tool, comprising:
a tip portion;
a body portion;
a head portion having a face surface; and
wherein the head portion comprises a ceramic body secured in a metal portion by an interference fit.

2. The punch tool of claim 1 wherein the ceramic body comprises at least 50% of the face surface of the head portion.

3. The punch tool of claim 1 wherein the ceramic body comprises at least 75% of the face surface of the head portion.

4. A method of making a punch tool having a ceramic portion, comprising:
providing a punch tool having a head portion;
forming a cavity in the head portion;
heating the punch tool to increase the diameter of the cavity;
inserting a ceramic body into the cavity;
cooling the punch tool to contract the cavity and secure the ceramic body therein.

5. The method of claim 4, wherein the ceramic body comprises at least 50% of the surface of the head portion.

6. The method of claim 4, wherein the ceramic body comprises at least 75% of the surface of the head portion.

7. A punch tool, comprising:
a tip portion;
a body portion; and
a head portion;
wherein the tip portion and the body portion are metal;
wherein the head portion comprises a ceramic body secured to the body portion by an interference fit.
